(19) United States
(12) Patent Application Publication
(10) Pub. No.: US 2017/0063011 A1
(43) Pub. Date: Mar. 2, 2017

(54) CFast Card Slot Breakout Cable

(71) Applicant: Electronic Product Solutions LLC, Concord, MA (US)

(72) Inventor: Doug Girdwood, Concord, MA (US)

(21) Appl. No.: 15/241,267

(22) Filed: Aug. 19, 2016

Related U.S. Application Data
(60) Provisional application No. 62/209,044, filed on Aug. 24, 2015.

(51) Int. Cl. H01R 31/06; H01R 24/62

(52) U.S. Cl. CPC H01R 31/06; H01R 24/62; H01R 2107/00

(57) ABSTRACT

A CFast card slot breakout cable supports the connection of a host device, such as a video camera or computer, to an externally located SATA compatible storage device through the host device's CFast card slot. The breakout cable supports the expansion of existing CFast slots to connect to substantially larger and more cost-effective external digital storage than can be directly provided by CFast data storage cards. The breakout cable uses a card housing with the form factor of a CFast memory card and plugs into a CFast card slot to tap into the data and optionally power signals. The card housing acts as a regular CFast card for installation into a host device slot and passes some or all of the electrical connections from the CFast card slot through industry standard Serial ATA cables and connectors for use with industry standard Serial ATA storage devices.

### RELATED APPLICATIONS

The subject matter of this application is related to U.S. Provisional Application No. 62/209,044, filed on Aug. 24, 2015, which is incorporated herein by reference in its entirety.

### BACKGROUND

CFast memory cards, which conform to an industry standard form factor, are limited in capacity and relatively expensive compared to other storage technologies such as hard disk drives. CFast memory cards use electrical connections and a protocol that are compatible with the Serial ATA computer bus interface standard that is used by many external and internal storage devices, such as hard disk drives.

### SUMMARY

A CFast card slot breakout cable supports the connection of a host device, such as a video camera or computer, to an externally located SATA compatible storage device through the host device's CFast card slot. The breakout cable supports the expansion of existing CFast slots to connect to substantially larger and more cost-effective external digital storage than can be directly provided by CFast data storage cards. The breakout cable uses a card housing with the form factor of a CFast memory card and plugs into a CFast card slot to tap into the data and optionally power signals. The card housing acts as a regular CFast card for installation into a host device slot and passes some or all of the electrical connections from the CFast card slot through industry standard Serial ATA (SATA) cables and connectors for use with industry standard SATA storage devices.

In certain embodiments, only data electrical connections are extracted and supplied through the cable to a SATA-compliant storage device, with the storage device deriving power from a separate external source. In other embodiments, both data and power are extracted and supplied through one or more cables to a SATA-compliant storage device.

In one aspect, a memory card slot breakout cable includes a card housing configured for physical receipt within an industry standard memory card slot; an electrical connector disposed within the card housing, the electrical connector comprising a plurality of electrical contacts configured to electrically interface with electrical contacts of the industry standard memory card slot; and a data cable having electrical leads for transferring digital computer signals, the data cable having an industry standard plug connector at a first end and having a second end embedded within the card housing, wherein the electrical leads for transferring digital computer signals are electrically connected at the second end to the electrical connector within the card housing.

The memory card slot breakout cable can further include a power cable having one or more electrical leads for transferring electrical power, the power cable having an industry standard plug connector at a first end and having a second end embedded within the card housing, wherein the electrical leads for transferring electrical power are electrically connected at the second end to the electrical connector within the card housing.

The memory card slot breakout cable can be configured such that the industry standard plug connector of the data cable is combined with the industry standard plug connector of the power cable in a single plug connector.

The memory card slot breakout cable can be configured such that the industry standard memory card slot is a CFast memory card slot.

The memory card slot breakout cable can be configured such that the industry standard plug connector of the data cable is an internal SATA data connector.

The memory card slot breakout cable can be configured such that the industry standard memory card slot is a CFast memory card slot.

The memory card slot breakout cable can be configured such that the industry standard plug connector of the data cable is an internal SATA data connector.

The memory card slot breakout cable can be configured such that the industry standard plug connector of the data cable is an eSATA data connector.

The memory card slot breakout cable can be configured such that the second end of the data cable is embedded within the card housing using a potting epoxy.

In one aspect, a method of electrically connecting a host device to a memory storage device includes: providing a memory card slot breakout cable including: a card housing configured for physical receipt within an industry standard memory card slot, an electrical connector disposed within the card housing, the electrical connector comprising a plurality of electrical contacts configured to electrically interface with electrical contacts of the industry standard memory card slot, and a data cable having electrical leads for transferring digital computer signals, the data cable having an industry standard plug connector at a first end and having a second end embedded within the card housing, wherein the electrical leads for transferring digital computer signals are electrically connected at the second end to the electrical connector within the card housing; inserting the card housing of the memory card slot breakout cable into a memory card slot of the host device; and connecting the plug connector of the memory card slot breakout cable to the memory storage device.

The method cam be performed such that the memory card slot breakout cable further includes a power cable having one or more electrical leads for transferring electrical power, the power cable having an industry standard plug connector at a first end and having a second end embedded within the card housing, wherein the electrical leads for transferring electrical power are electrically connected at the second end to the electrical connector within the card housing.

The method cam be performed such that the industry standard plug connector of the data cable is combined with the industry standard plug connector of the power cable in a single plug connector.

The method cam be performed such that the industry standard memory card slot is a CFast memory card slot.

The method cam be performed such that the industry standard plug connector of the data cable is an internal SATA data connector.

The method cam be performed such that the industry standard memory card slot is a CFast memory card slot.

The method cam be performed such that the industry standard plug connector of the data cable is an internal SATA data connector.

The method cam be performed such that the industry standard plug connector of the data cable is an eSATA data connector.

The method cam be performed such that the second end of the data cable is embedded within the card housing using a potting epoxy.

### BRIEF DESCRIPTION OF THE DRAWINGS

FIG. 1 illustrates a CFast card slot breakout cable in accordance with a first embodiment.

FIG. 2 illustrates a breakout cable in accordance with a second embodiment.

FIG. 3 illustrates a breakout cable in accordance with a third embodiment.

FIG. 4 illustrates a breakout cable in accordance with a fourth embodiment.

FIG. 5 illustrates a drawing of a partially assembled breakout cable showing data and power cable connections on the card housing.

FIG. 6 illustrates a drawing of an assembled breakout cable showing the card housing.

FIG. 7 illustrates a schematic of internal electrical connections in a data-only embodiment of a breakout cable card housing.

FIG. 8 illustrates a schematic of internal electrical connections in a data and power embodiment of a breakout cable card housing.

### DETAILED DESCRIPTION

In the following description, references are made to various embodiments in accordance with which the disclosed subject matter can be practiced. Multiple references to “one embodiment” or “an embodiment” do not necessarily refer to the same embodiment. Particular features, structures or characteristics associated with such embodiments can be combined in any suitable manner in various embodiments. References are also made to the accompanying drawings in which the same reference numbers are used throughout to refer to the same or like components.

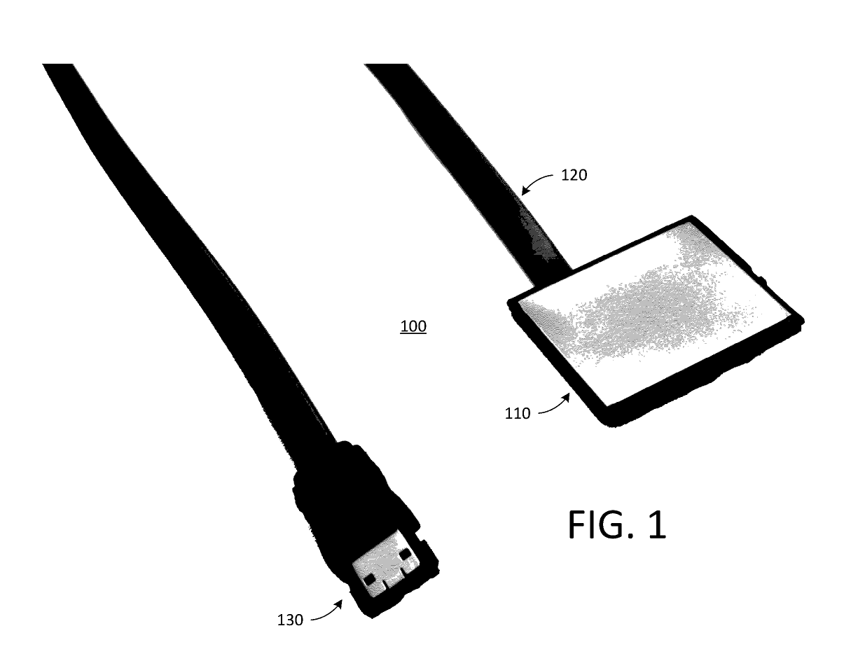

FIG. 1 illustrates a CFast card slot breakout cable 100 in accordance with a first embodiment. The breakout cable 100 includes a card housing 110, a data cable 120, and a data connector 130. The card housing 110 is configured in the form of a CFast data storage card, including its standard electrical contacts. The data cable 120 can be a flexible SATA 7 lead data cable compliant with industry standards. The data cable 120 is electrically connected to the standard electrical contacts of the card housing 110 to match industry standard SATA electrical data connections. At an opposite end, the data cable 120 is connected to an industry standard SATA data connector 130 to match industry standard Serial ATA data connections. In the first embodiment, as illustrated, the data connector 130 and cable 120 are an industry standard eSATA connector cable.

The breakout cable 100 extracts the signal from a CFast card slot of a host device, such as a video camera or computer, and is used to connect the host device to an externally located SATA compatible storage device, such as a hard drive, through the CFast card slot. Depending on configuration, the hard drive can be an internal or external hard drive and can be a conventional hard drive, a solid state drive or any other storage device compatible with SATA standards. The data breakout cable 100 can also be used for testing a host device.

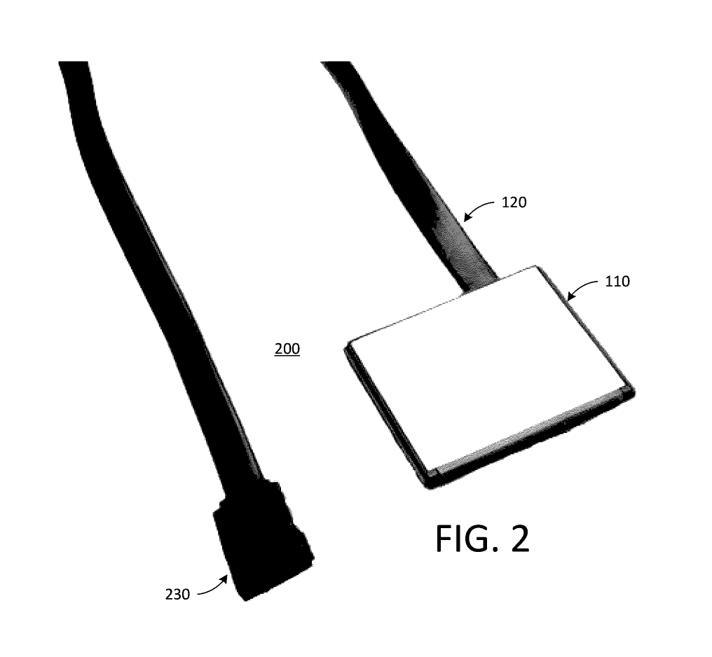

FIG. 2 illustrates a breakout cable 200 in accordance with a second embodiment. In the second embodiment, the data connector 230 at the opposite end of the data cable 120 is an industry standard internal SATA data connector.

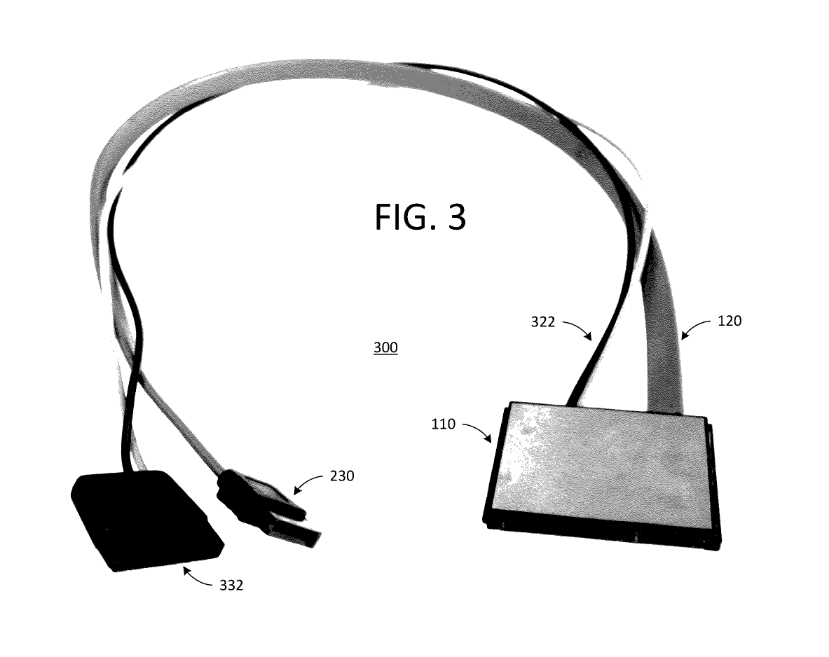

FIG. 3 illustrates a breakout cable 300 in accordance with a third embodiment. In the third embodiment, industry standard electrical contacts of the card housing 110 extract 3.3 volt DC power from the CFast card slot. These power-supplying electrical contacts of the card housing 110 are electrically connected through a power cable 322 to an industry standard SATA power connector 332. The power cable 322 can include one or more separate or combined wires or leads. The power connector 332, in turn, can be used to power certain SATA devices configured to operate using 3.3 volt DC power. Most SATA drives, however, operate at 5 volts DC power.

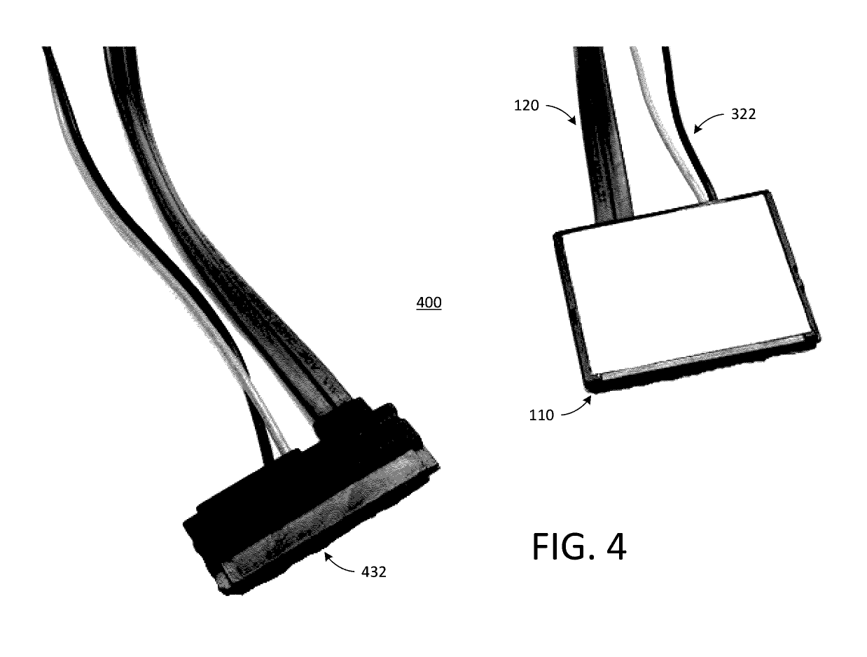

FIG. 4 illustrates a breakout cable 400 in accordance with a fourth embodiment. The breakout cable 400 of the fourth embodiment operates to supply power and data similarly to the breakout cable 300 of the third embodiment, but the data connector 130 and the power connector 332 have been combined into a single industry standard power and data connector 432.

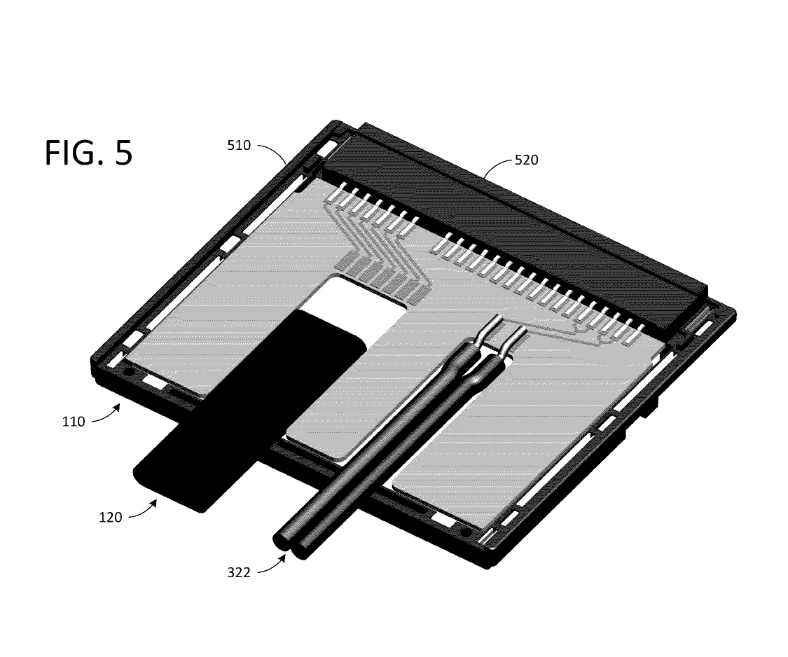

FIG. 5 illustrates a drawing of a partially assembled breakout cable showing data and power cable connections on the card housing 110. The card housing 110 can include a shell enclosure 510, typically of molded plastic. The card housing also can include a CFast electrical connector 520, which makes electrical connections to a CFast card slot and passes the electrical connections through to the cables 120 and 322. The cables 120 and 322 can be soldered to the electrical connector 520. The shell enclosure 510 can include slots through which the cables 120 and 322 pass. The cables 120 and 322 can be set, embedded and secured using a potting epoxy disposed within the shell enclosure 510.

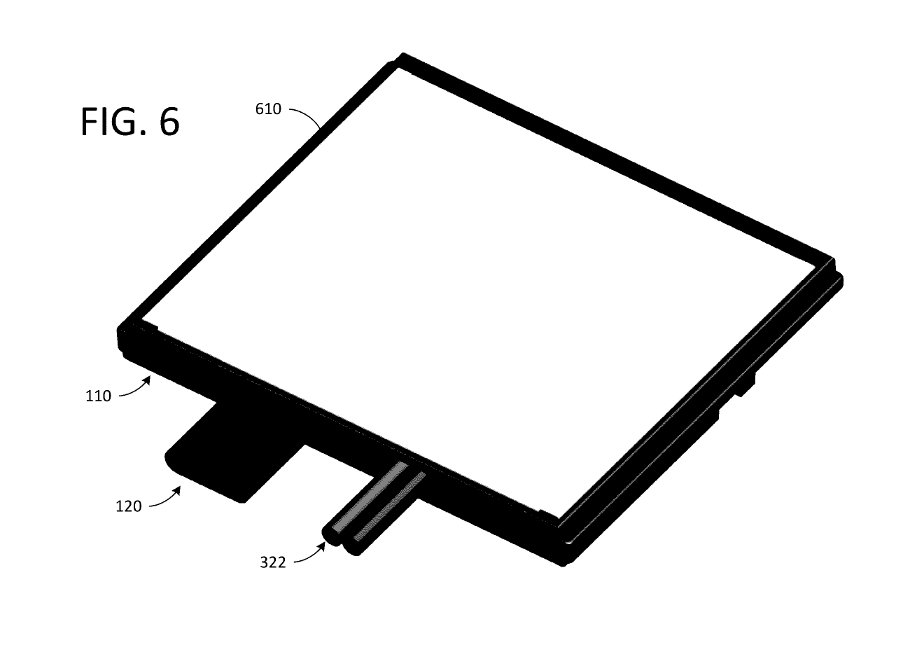

FIG. 6 illustrates a drawing of an assembled breakout cable showing the card housing 110. A cover 620, typically of molded plastic and/or metal, can be added over the shell enclosure 510 to cover the cables potted with epoxy, and the cover 610 and shell enclosure 510 can be sealed together using high pressure. The assembled cable 100 can be cured and dried for a permanent seal, and then the electrical connections can be tested.

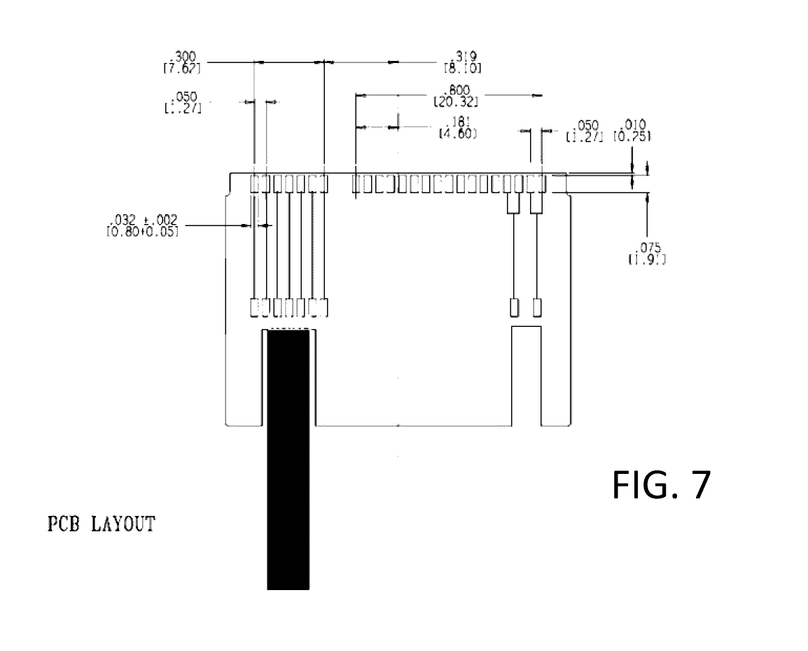

FIG. 7 illustrates a schematic of internal electrical connections in a data-only embodiment of a breakout cable card housing.

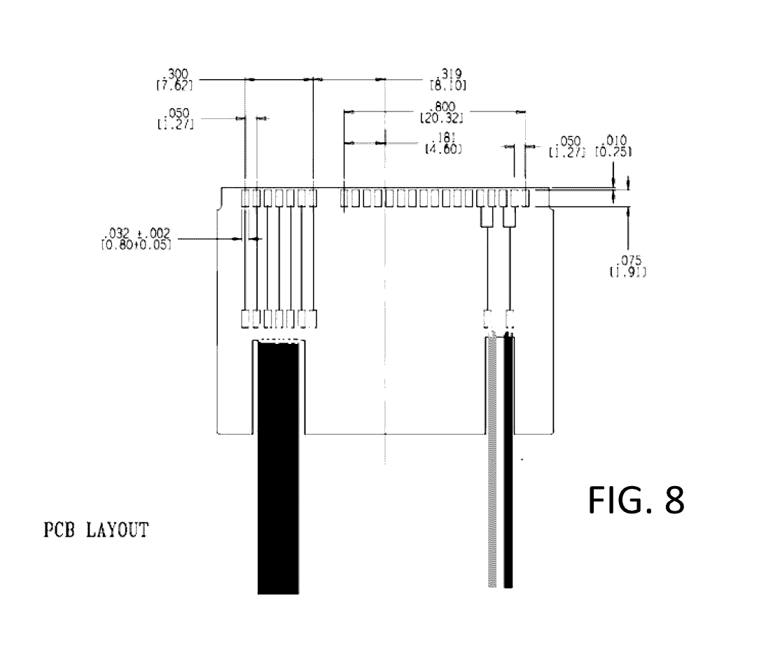

FIG. 8 illustrates a schematic of internal electrical connections in a data and power embodiment of a breakout cable card housing.

Although the subject matter has been described in terms of certain embodiments, other embodiments, including embodiments which may or may not provide various features and advantages set forth herein will be apparent to those of ordinary skill in the art in view of the foregoing disclosure. The specific embodiments described above are disclosed as examples only, and the scope of the patented subject matter is defined by the claims that follow.

1. A memory card slot breakout cable comprising:
a card housing configured for physical receipt within an industry standard memory card slot;
an electrical connector disposed within the card housing, the electrical connector comprising a plurality of electrical contacts configured to electrically interface with electrical contacts of the industry standard memory card slot; and
a data cable having electrical leads for transferring digital computer signals, the data cable having an industry standard plug connector at a first end and having a second end embedded within the card housing, wherein the electrical leads for transferring digital computer signals are electrically connected at the second end to the electrical connector within the card housing.

2. The memory card slot breakout cable of claim 1, further comprising:
a power cable having one or more electrical leads for transferring electrical power, the power cable having an industry standard plug connector at a first end and having a second end embedded within the card housing, wherein the electrical leads for transferring electrical power are electrically connected at the second end to the electrical connector within the card housing.

3. The memory card slot breakout cable of claim 2, wherein the industry standard plug connector of the data cable is combined with the industry standard plug connector of the power cable in a single plug connector.

4. The memory card slot breakout cable of claim 2, wherein the industry standard memory card slot is a CFast memory card slot.

5. The memory card slot breakout cable of claim 2, wherein the industry standard plug connector of the data cable is an internal SATA data connector.

6. The memory card slot breakout cable of claim 1, wherein the industry standard memory card slot is a CFast memory card slot.

7. The memory card slot breakout cable of claim 1, wherein the industry standard plug connector of the data cable is an internal SATA data connector.

8. The memory card slot breakout cable of claim 1, wherein the industry standard plug connector of the data cable is an eSATA data connector.

9. The memory card slot breakout cable of claim 1, wherein the second end of the data cable is embedded within the card housing using a potting epoxy.

10. A method of electrically connecting a host device to a memory storage device, the method comprising:
providing a memory card slot breakout cable comprising:
a card housing configured for physical receipt within an industry standard memory card slot,
an electrical connector disposed within the card housing, the electrical connector comprising a plurality of electrical contacts configured to electrically interface with electrical contacts of the industry standard memory card slot, and
a data cable having electrical leads for transferring digital computer signals, the data cable having an industry standard plug connector at a first end and having a second end embedded within the card housing, wherein the electrical leads for transferring digital computer signals are electrically connected at the second end to the electrical connector within the card housing;
inserting the card housing of the memory card slot breakout cable into a memory card slot of the host device; and
connecting the plug connector of the memory card slot breakout cable to the memory storage device.

11. The method of claim 10, wherein the memory card slot breakout cable further comprises:
a power cable having one or more electrical leads for transferring electrical power, the power cable having an industry standard plug connector at a first end and having a second end embedded within the card housing, wherein the electrical leads for transferring electrical power are electrically connected at the second end to the electrical connector within the card housing.

12. The method of claim 11, wherein the industry standard plug connector of the data cable is combined with the industry standard plug connector of the power cable in a single plug connector.

13. The method of claim 11, wherein the industry standard memory card slot is a CFast memory card slot.

14. The method of claim 11, wherein the industry standard plug connector of the data cable is an internal SATA data connector.

15. The method of claim 10, wherein the industry standard memory card slot is a CFast memory card slot.

16. The method of claim 10, wherein the industry standard plug connector of the data cable is an internal SATA data connector.

17. The method of claim 10, wherein the industry standard plug connector of the data cable is an eSATA data connector.

18. The method of claim 10, wherein the second end of the data cable is embedded within the card housing using a potting epoxy.
